(19) United States
(12) Patent Application Publication
(10) Pub. No.: US 2019/0362660 A1
(43) Pub. Date: Nov. 28, 2019

(54) ENGINEERING TOOL

(71) Applicant: Mitsubishi Electric Corporation, Tokyo (JP)

(72) Inventor: Motoki TOMITA, Aichi (JP)

(73) Assignee: Mitsubishi Electric Corporation, Tokyo (JP)

(21) Appl. No.: 16/337,397

(22) PCT Filed: Mar. 28, 2017
(86) PCT No.: PCT/JP2017/012741

§ 371 Date: Mar. 27, 2019

(51) Int. Cl. G09G 3/00; G06F 3/14

(52) U.S. Cl. CPC G09G 3/006; G09G 2380/04; G06F 3/1423

(57) ABSTRACT

An engineering tool of a programmable display includes an internal device search unit that obtains data including a device or a label from the programmable display and searches the obtained data for first data including an internal device that is a device used when the programmable display is operated and second data including a label indicating the internal device and a list display processing unit that reads out a device value corresponding to the internal device included in the first data and the device value corresponding to the label included in the second data from the programmable display and makes a display unit display the read out device values.

### FIELD

The present invention relates to an engineering tool used for verifying an operation of a programmable display.

### BACKGROUND

A programmable display is connected to a device such as a Programmable Logic Controller (PLC), a sensor, and a driving device used in a production site, displays a state of the connected device, and operates the devices.

Some programmable displays are configured so as to promptly identify a cause of a case where a desired result cannot be obtained when the connected device is operated (Patent Literature 1).

The programmable display described in Patent Literature 1 has a function of operating in a debug mode as a function of identifying the cause of a case where a desired result cannot be obtained even when the PLC is operated. In the debug mode, device values of devices related to components selected by an operator from among components displayed on an operation screen of the programmable display are displayed. With this display, the device value related to the cause of the failure can be easily confirmed, and the cause can be promptly identified.

### CITATION LIST

### Patent Literature

Patent Literature 1: Japanese Patent Application Laid-Open No. 2013-105218

### SUMMARY

### Technical Problem

However, with the invention described in Patent Literature 1, it is difficult to identify a cause of a failure occurred in a programmable display. That is, according to the invention described in Patent Literature 1, in a case where a failure occurs in a PLC connected to the programmable display or a device controlled by the PLC, a related device value can be displayed, and an operator can easily confirm the device value. However, a device value of a device related to the failure of the programmable display cannot be confirmed. Until now, in a case where a failure occurs in the programmable display, it has been necessary to recognize a state of the programmable display by reading out device values of all the devices from a memory of the programmable display by using a maintenance tool and the like and selecting and confirming the device value related to the operation of the programmable display from among the read out device values by a user. The user used to determine whether or not the device value is related to the operation of the programmable display by referring to a manual of the programmable display and the like. In this way, since a work for identifying the cause of the failure occurred in the programmable display is complicated, it has been desired to reduce a workload.

The present invention has been made in consideration of the above, and an object of the present invention is to obtain an engineering tool capable of reducing the number of man-hours of a user when a cause of a failure occurred in a programmable display is identified.

### Solution to Problem

To solve the above problems and to achieve the object, the present invention is an engineering tool of a programmable display that includes an internal device search unit. The internal device search unit obtains data including a device or a label from the programmable display and searches, targeting the obtained data, for first data including the internal device that is a device used when the programmable display is operated and second data including the label indicating the internal device. Furthermore, the engineering tool includes a list display processing unit that reads out the device value corresponding to the internal device included in the first data and the device value corresponding to the label included in the second data from the programmable display and causes a display unit to display the read out device values.

### Advantageous Effects of Invention

An engineering tool according to the present invention has an effect of reducing the number of man-hours of a user in identifying a cause of a failure occurred in a programmable display.

### BRIEF DESCRIPTION OF DRAWINGS

FIG. 1 is a diagram illustrating an exemplary configuration of an engineering tool according to an embodiment of the present invention.

FIG. 2 is a diagram illustrating an example of data stored in a storage unit of the engineering tool.

FIG. 3 is a diagram illustrating an exemplary configuration of hardware for realizing the engineering tool.

FIG. 4 is a diagram of an example of data stored in a storage unit of a display.

FIG. 5 is a flowchart illustrating an exemplary operation of an internal device search unit of the engineering tool.

FIG. 6 is a diagram illustrating an example of a list of internal devices generated by the internal device search unit.

FIG. 7 is a flowchart illustrating an exemplary operation of a list display processing unit of the engineering tool.

FIG. 8 is a diagram of a content of an operation executed by the list display processing unit of the engineering tool.

FIG. 9 is a diagram illustrating an exemplary screen displayed on a display unit of the engineering tool.

FIG. 10 is a diagram illustrating another example of the screen displayed on the display unit of the engineering tool.

### DESCRIPTION OF EMBODIMENTS

Hereinafter, an engineering tool according to an embodiment of the present invention will be described in detail with reference to the drawings. The present invention is not limited to the embodiment.

### Embodiment

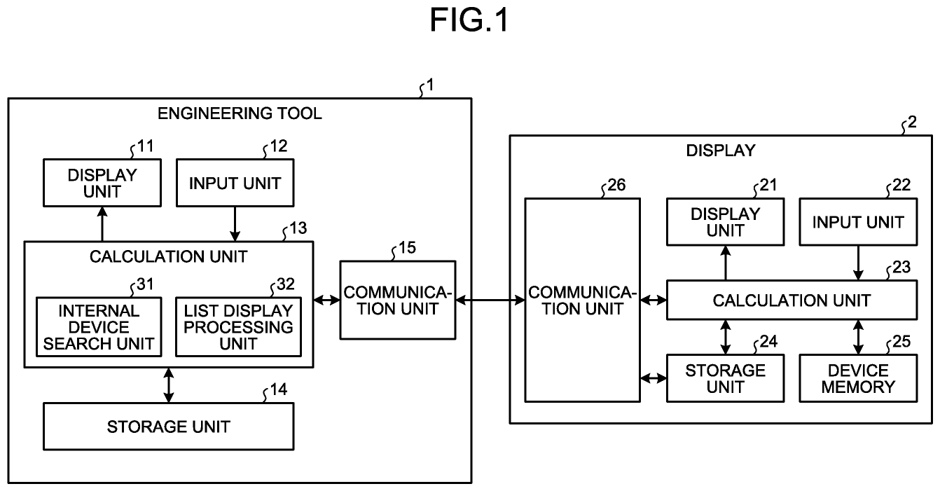

FIG. 1 is a diagram illustrating an exemplary configuration of an engineering tool according to an embodiment of the present invention. In FIG. 1, a display 2 connected to an engineering tool 1 according to the present embodiment is also illustrated. The display 2 is a programmable display. The engineering tool 1 is a tool used for developing a program for operating the display 2. The engineering tool 1 has a function of creating and editing the program for operating the display 2 and has a function of investigating a cause of a failure occurred in the display 2. In a case where the engineering tool 1 is used for investigating the cause of the failure occurred in the display 2, the engineering tool 1 operates in a state of being connected to the display 2. FIG. 1 illustrates an example in a case where the engineering tool 1 is used for investigating the cause of the failure occurred in the display 2, and components used for creating and editing the program for operating the display 2 are omitted. Each component of the engineering tool 1 illustrated in FIG. 1 is needed in a case where the engineering tool 1 is used for investigating the cause of the failure occurred in the display 2.

The engineering tool 1 includes a display unit 11, an input unit 12, a calculation unit 13, a storage unit 14, and a communication unit 15. The calculation unit 13 includes an internal device search unit 31 and a list display processing unit 32. Each of the constituents is realized by executing software for realizing the engineering tool 1 by a computer.

In the engineering tool 1, the display unit 11 displays various screens including an operation screen of the engineering tool 1. The input unit 12 receives an operation related to the engineering tool 1 from a user. The calculation unit 13 executes calculation processing for realizing various functions included in the engineering tool 1. The internal device search unit 31 searches first data including an internal device and second data including a label indicating the internal device from among data held by the display 2. The internal device according to the present embodiment indicates a device included in the display 2. The device corresponds to a variable in a general program and the like. The list display processing unit 32 displays the internal device, an internal device value, and information related to the internal device on the display unit 11 in a list format. The internal device value is a device value of the internal device.

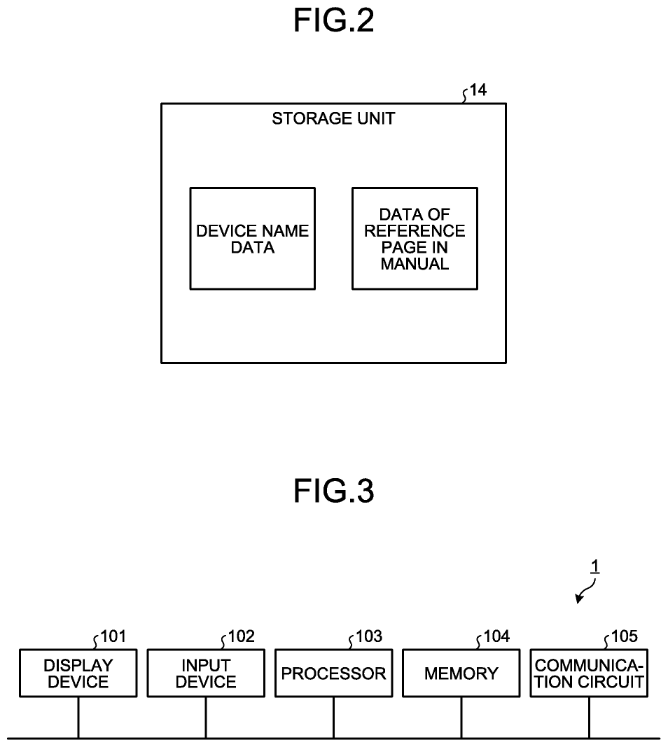

The storage unit 14 stores various data used by the engineering tool 1. An example of data stored in the storage unit 14 is illustrated in FIG. 2. FIG. 2 is a diagram illustrating an example of data stored in the storage unit 14 of the engineering tool 1. The storage unit 14 stores, for example, device name data and data of a reference page in a manual. The device name data is a table illustrating a relationship between a name given to each device in advance which can be used for the program for operating the display 2 and each device. The device name data corresponds to a “correspondence table of the device and the name” to be described later. The name is constituted by character information or a character code; and the device is constituted by alphabets and numerical values. In the devices which can be used for the program, there is a device to which the name is not given and is managed by using only information on the device, that is, information obtained by combining the alphabets and the numbers. The data of the reference page in the manual is information indicating the page of the manual where description of each device which can be used for the program for operating the display 2 is written. That is, the data of the reference page in the manual is a table illustrating a relationship between each device and the page of the manual where the description of the device is written. The “name which has been given to the device in advance” is a name used in the description written in the manual.

The data illustrated in FIG. 2, that is, the data including the device name data table and the reference page in the manual is written in the storage unit 14 when software for realizing the engineering tool 1 is installed to a computer. In FIG. 2, particularly important data in the data stored in the storage unit 14 is illustrated. The data stored in the storage unit 14 is not limited to the data illustrated in FIG. 2.

The communication unit 15 is connected to a communication line used to communicate with the display 2 and exchanges signals with the display 2.

Here, a configuration of hardware for realizing the engineering tool 1 will be described. FIG. 3 is a diagram illustrating an exemplary configuration of the hardware for realizing the engineering tool 1. The engineering tool 1 is realized by a display device 101, an input device 102, a processor 103, a memory 104, and a communication circuit 105.

The display device 101 is a liquid crystal monitor, a display, and the like. The input device 102 is a keyboard, a mouse, and the like. The processor 103 is a Central Processing Unit (CPU) (referred to as central processing device, processing device, calculation device, microprocessor, microcomputer, processor, and Digital Signal Processor (DSP)) and the like. The memory 104 is a nonvolatile or volatile semiconductor memory such as a Random Access Memory (RAM), a Read Only Memory (ROM), and a flash memory, a magnetic disk, and the like. The communication circuit 105 is a processing circuit which exchanges signals with the display 2.

The display unit 11, the input unit 12, the storage unit 14, and the communication unit 15 illustrated in FIG. 1 are respectively realized by the display device 101, the input device 102, the memory 104, and the communication circuit 105 illustrated in FIG. 3. Furthermore, the internal device search unit 31 and the list display processing unit 32 in the calculation unit 13 illustrated in FIG. 1 are respectively realized by the processor 103 and the memory 104. Specifically, the internal device search unit 31 and the list display processing unit 32 are realized as the processor 103 reads out and executes the program for making the internal device search unit 31 and the list display processing unit 32 operate as such. It is assumed that the memory 104 holds the program that operates as the internal device search unit 31 and the list display processing unit 32 in advance.

Returning to the description in FIG. 1, the display 2 includes a display unit 21, an input unit 22, a calculation unit 23, a storage unit 24, a device memory 25, and a communication unit 26. Although not illustrated, the display 2 is connected to external devices such as a PLC, a sensor, and a driving device. The display 2 has a function of controlling the connected external device and a function of displaying a condition of the control of the external device and a state of the external device on the display unit 21.

In the display 2, the display unit 21 displays various screens including an operation screen of the display 2. The input unit 22 receives an operation related to the display 2 from a user. The calculation unit 23 executes calculation processing for realizing various functions included in the display 2.

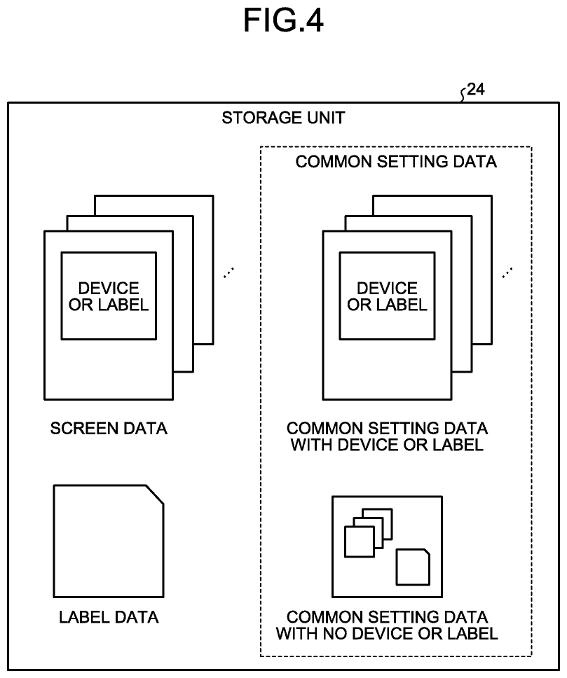

The storage unit 24 stores various data used by the display 2. An example of data stored in the storage unit 24 is illustrated in FIG. 4. FIG. 4 is a diagram illustrating an example of data stored in the storage unit 24 of the display 2. The storage unit 24 stores, for example, screen data, label data, and common setting data. These data is data included in the program for operating the display 2 or data used by the program for operating the display 2.

The screen data is data of a screen displayed on the display unit 21 of the display 2 and includes information necessary for displaying of the screen such as a shape, a color, a display position, and the like of the screen. Various information necessary for displaying a single screen is included in a single piece of screen data. Furthermore, the screen data includes a device or a label. The single piece of screen data includes one or more devices or labels. The label is information corresponding to the name of the device and is given to the device by the user. The user can give an arbitrary label to an arbitrary device. In a case where the device is written in the program, the label can be used instead of the device for the device to which the label has been given. The label is different from the “name which has been given to the device in advance”.

The label data is a table indicating a relationship between the label given to the device and the device, that is, which label is given to which device. The label data is updated when the correspondence relation between the device and the label changes, for example, in a case where a label is newly given to a device and a case where the label given to the device is changed.

The common setting data is data used when a screen is displayed on the display unit 21 of the display 2 based on the screen data and data used for controlling the device connected to the display 2. The common setting data corresponds to, for example, a timing when the display of the screen is updated, a condition for updating the display of the screen, and the like. Some common setting data includes one or more devices or labels as the screen data described above. Furthermore, some common setting data includes none of the device and the label.

The device memory 25 is a memory for storing the device value of each device included in the data stored in the storage unit 24. In the exemplary configuration illustrated in FIG. 1, the storage unit 24 and the device memory 25 are separately configured. However, the storage unit 24 may include the device memory 25. That is, a region for storing the device value of each device may be provided in the storage unit 24.

The communication unit 26 is connected to a communication line used to communicate with the engineering tool 1 and exchanges signals with the engineering tool 1.

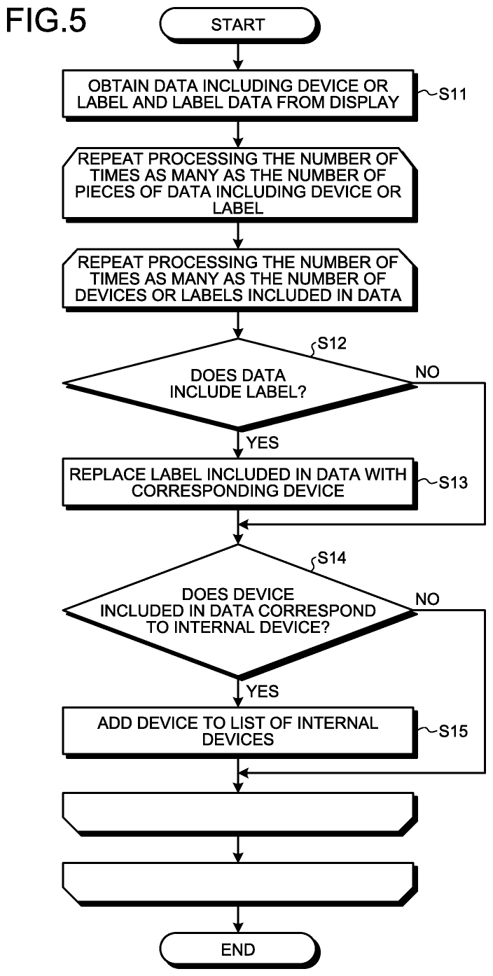

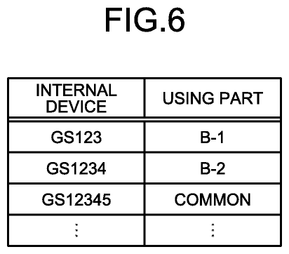

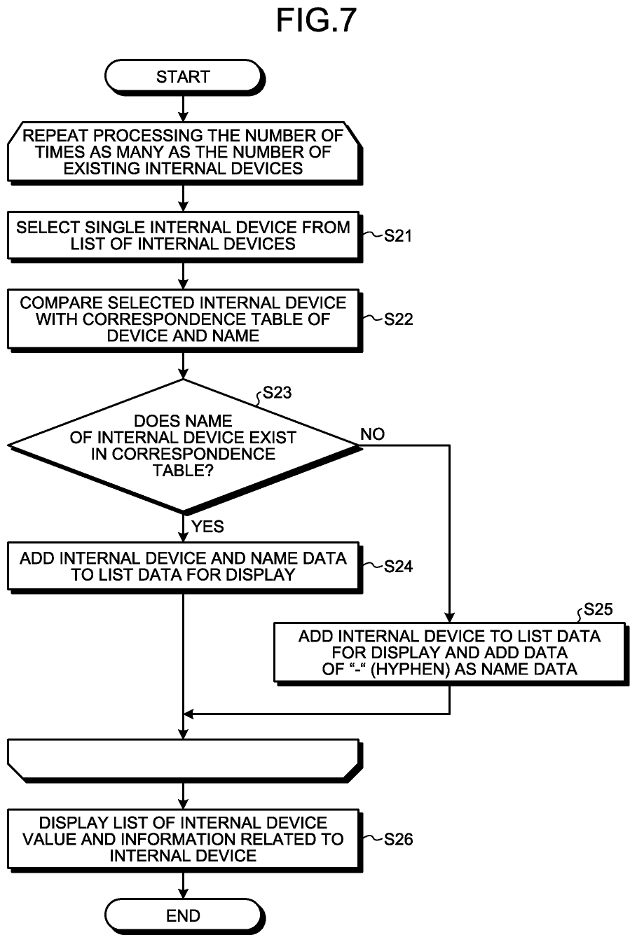

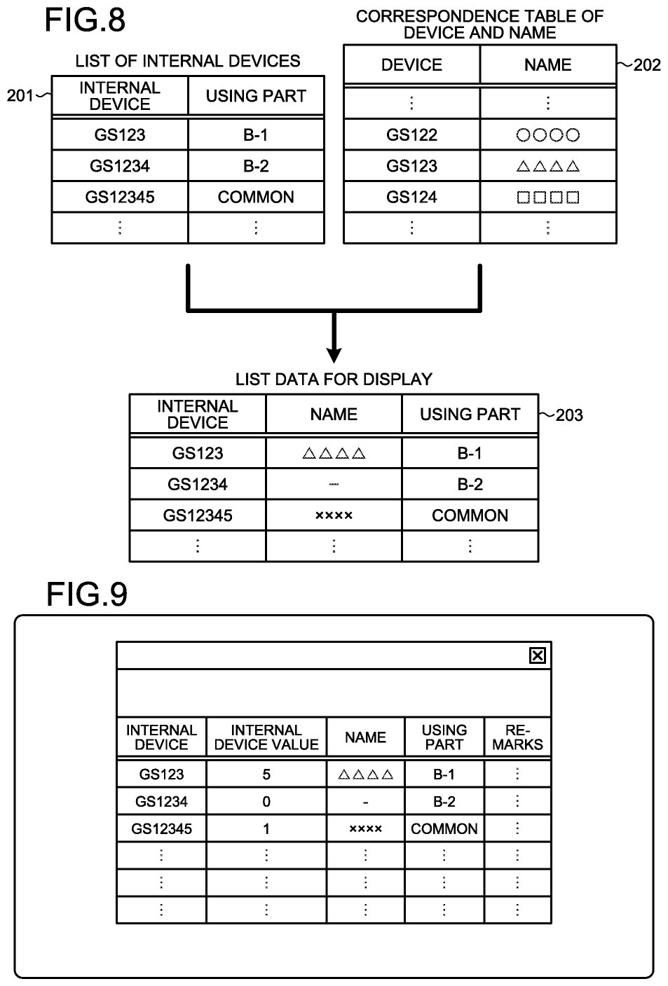

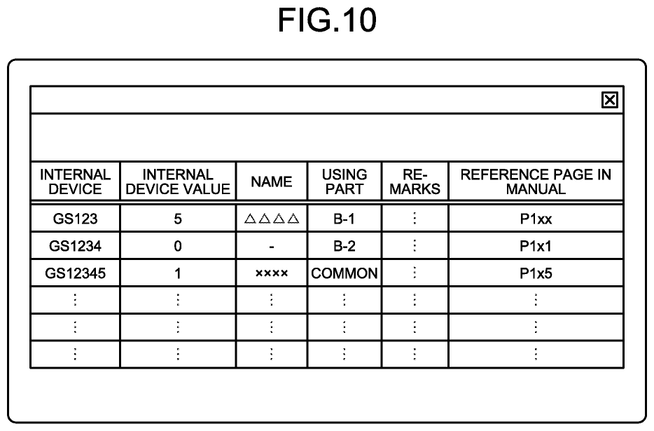

Subsequently, an overall operation of the engineering tool 1 will be described. Specifically, an operation of the engineering tool 1 for obtaining the internal device value which is the device value of the internal device from the display 2 and displaying a list of the obtained internal device values will be described with reference to FIGS. 5 to 10. FIG. 5 is a flowchart illustrating an exemplary operation of the internal device search unit 31 of the engineering tool 1. FIG. 6 is a diagram illustrating an example of a list of the internal devices generated by the internal device search unit 31. FIG. 7 is a flowchart illustrating an exemplary operation of the list display processing unit 32 of the engineering tool 1. FIG. 8 is a diagram illustrating a content of an operation executed by the list display processing unit 32 of the engineering tool 1. FIG. 9 is a diagram illustrating an exemplary screen displayed on the display unit 11 of the engineering tool 1. FIG. 10 is a diagram illustrating another exemplary screen displayed on the display unit 11 of the engineering tool 1.

First, an operation for generating the list of the internal devices by the internal device search unit 31 of the engineering tool 1 will be described with reference to the flowchart illustrated in FIG. 5. When the input unit 12 receives an operation for instructing to start to display the list of the internal device values from the user, the internal device search unit 31 starts the operation according to the flowchart illustrated in FIG. 5.

In a case where the input unit 12 receives the operation for instructing to start to display the list of the internal device values from the user, the internal device search unit 31 obtains the data including the device or the label and the label data from the display 2 (step S11). Specifically, the internal device search unit 31 requests the display 2 via the communication unit 15 to transmit the screen data, the common setting data, and the label data illustrated in FIG. 4. The display 2 which has received the request transmits the requested data to the engineering tool 1.

Next, the internal device search unit 31 repeatedly executes the processing in steps S12 to S15 illustrated in FIG. 5 with respect to each device and each label included in each data obtained in step S11. That is, the internal device search unit 31 selects a single piece of data from among a plurality of pieces of data including the device or the label and repeats the processing in steps S12 to S15 with respect to each device and each label included in the selected data. When executing the processing in steps S12 to S15 with respect to all the devices and labels included in the selected data, the internal device search unit 31 selects a next single piece of data from among the plurality of pieces of data including the device or the label and repeats the processing in steps S12 to S15 with respect to each device and each label included in the selected data. The internal device search unit 31 repeats the similar processing below. This operation corresponds to an operation for searching for the first data including the internal device and the second data including the label indicating the internal device.

In step S12, the internal device search unit 31 confirms the selected data and confirms whether or not the label is included in the data. Specifically, the internal device search unit 31 refers to the “label data” obtained in step S11 and determines whether or not the label is included in the selected data. In a case where the label is included in the selected data (step S12: Yes), the internal device search unit 31 replaces the label included in the selected data with the corresponding device (step S13).

After executing step S13, the internal device search unit 31 confirms whether or not the device included in the selected data corresponds to the internal device (step S14). In general, the internal device and the device other than the internal device have different configurations, that is, configurations of information indicating the device obtained by combining alphabets and numbers. For example, regarding the internal device and the device other than the internal device, at least one of the alphabets and numbers of high-order several digits of the information indicating the internal device and the device other than the internal device are different from each other. Therefore, the internal device search unit 31 confirms a portion, which is different between the internal device and the device other than the internal device, of the device included in the selected data and determines whether or not the device included in the selected data corresponds to the internal device. The internal device search unit 31 may use a list of the internal devices and the like and confirm whether or not the device included in the selected data exists in the list to determine whether or not the device included in the selected data corresponds to the internal device.

In a case where the label is not included in the selected data (step S12: No), the internal device search unit 31 executes step S14.

In a case where the device included in the selected data does not correspond to the internal device (step S14: No), the internal device search unit 31 selects next data, that is, a single piece of data from among data to which the processing in steps S12 to S15 is not executed and executes step S12 and subsequent steps.

In a case where the device included in the selected data is the internal device (step S14: Yes), the internal device search unit 31 adds the device included in the selected data to the list of the internal devices (step S15).

After executing step S15, the internal device search unit 31 selects the next data and executes step S12 and the subsequent steps.

When the internal device search unit 31 has executed the processing in steps S12 to S15 with respect to all the data including the device or the label, the list of the internal devices is completed (refer to FIG. 6). In FIG. 6, character strings “GS123” and “GS1234” written in the column of the “internal device” indicate the internal devices, and character strings “B-1” and “B-2” written in the column of the “using part” indicate the data including the internal device. The character strings of “B-1” and “B-2” indicating the using part indicate management numbers of the screen data. That is, in FIG. 6 it is indicated that the internal device of which the “using part” is “B-1” is included in the screen data of which the management number is “B-1”, the internal device of which the “using part” is “B-2” is included in the screen data of which the management number is “B-2”, and the internal device of which the “using part” is “common” is included in the common setting data.

Next, an operation for displaying the list of the device values of the internal devices on the display unit 11 by the list display processing unit 32 of the engineering tool 1 will be described according to the flowchart illustrated in FIG. 7. When the processing by the internal device search unit 31 has been completed and the list of the internal devices has been generated, the list display processing unit 32 starts the operation according to the flowchart illustrated in FIG. 7.

In a case where the internal device search unit 31 has generated the list of the internal devices, the list display processing unit 32 repeatedly executes the processing in steps S21 to S25 illustrated in FIG. 7 the number of times as many as the number of existing internal devices. That is, the list display processing unit 32 repeatedly executes the processing in steps S21 to S25 with respect to each internal device included in the list of the internal devices.

In step S21, the list display processing unit 32 selects one internal device from the list of the internal devices. The list display processing unit 32 compares the selected internal device with a correspondence table of the device and the name, that is, the “device name data table” (step S22) and confirms whether or not the name of the internal device exists in the correspondence table (step S23).

In a case where the name corresponding to the selected internal device exists in the correspondence table (step S23: Yes), the list display processing unit 32 adds the selected internal device and the corresponding name data to the list data for display (step S24). The list data for display will be separately described with reference to FIG. 8. In a case where the name corresponding to the selected internal device does not exist in the correspondence table (step S23: No), the list display processing unit 32 adds the selected internal device to the list data for display and adds “-”, that is, data of a hyphen as the name data (step S25).

When the list display processing unit 32 has executed the processing in steps S21 to S25 with respect to all the internal devices included in the list of the internal devices, the list data for display is completed (refer to FIG. 8). The processing in steps S21 to S25 executed by the list display processing unit 32 corresponds to the operation illustrated in FIG. 8, specifically, corresponds: to search for the names corresponding to the internal devices included in an internal device list 201 from a correspondence table of the device and the name 202; to add the corresponding names to the internal device list 201; and to generate list data for display 203.

After executing the processing in steps S21 to S25 with respect to each internal device included in the list of the internal devices, the list display processing unit 32 displays lists of the internal device values and the information related to the internal device on the display unit 11 (step S26). In step S26, specifically, the list display processing unit 32 first reads out a device value of an internal device included in list data for display 203 from the device memory 25 of the display 2. The list display processing unit 32 reads out the device value of the internal device from the device memory 25 via the communication unit 15, the communication unit 26 and the calculation unit 23 of the display 2. In a case where the engineering tool 1 is configured to be able to access the device memory 25 without via the calculation unit 23 of the display 2, the list display processing unit 32 may read out the device value of the internal device from the device memory 25 without via the calculation unit 23. Next, the list display processing unit 32 displays each of the read out device values on the display unit 11 as the internal device values together with each piece of data included in the list data for display 203. At this time, the list display processing unit 32 displays a screen illustrated in FIG. 9 or 10 on the display unit 11. FIGS. 9 and 10 are representative examples of screens to be displayed. If a screen has another configuration including display of the internal device value and the information related to the internal device, the list display processing unit 32 may display the screen having the another configuration on the display unit 11. Each piece of information other than the internal device value corresponds to the information related to the internal device.

A list display screen illustrated in FIG. 9 includes fields of the “internal device”, the “internal device value”, the “name”, the using part”, and “remarks”. An internal device is displayed in the field of the “internal device”, a name of the internal device or a hyphen is displayed in the “name”, and information on data including the internal device is displayed in the “using part”. The field of the “remarks” is provided so that a user can input comments and the like. A screen configuration which does not include the field of the “remarks” may be used. In this way, since the engineering tool 1 displays the list of the device values of the internal devices which are devices used when the display 2 is operated, it is not necessary for the user to identify the device value of the device corresponding to the internal device, and a workload of the user is reduced.

In a case where the screen illustrated in FIG. 9 is displayed, the list display processing unit 32 uses the list data generated by repeatedly executing steps S21 to S25 and the internal device value corresponding to the internal device included in the list data. The list display processing unit 32 obtains a necessary internal device value from the display 2 via the communication unit 15.

In the screen illustrated in FIG. 10, a field of the “reference page in the manual” is added to the screen illustrated in FIG. 9. In the field of the “reference page in the manual”, a page number of the manual in which description of the internal device displayed in the same row is written is displayed.

In a case where the screen illustrated in FIG. 10 is displayed, the list display processing unit 32 uses: the list data generated by repeatedly executing steps S21 to S25; the internal device value corresponding to the internal device included in the list data; and the data of the reference page in the manual held by the storage unit 14. In a case where the screen configuration illustrated in FIG. 10 is used, since the page number of the manual in which the description of the internal device is written is displayed together, the page of the manual to be referred when a cause of a failure is investigated can be found at first sight, and a work efficiency can be further improved. Furthermore, since the name used in the description of the internal device is displayed together, even in a case where a plurality of internal devices is described in a single page, corresponding description can be easily found by using the name.

As described above, the engineering tool 1 according to the present embodiment: obtains the data including the device or the label from the display 2; identifies the data including the internal device which is a device used when the display 2 is operated or the label indicating the internal device from among the obtained data; and obtains the device value of the internal device from the display 2 to display the list. Accordingly, it is not necessary for the user to identify the device corresponding to the internal device from among all the devices, and the number of working man-hours of the user when a cause of a failure occurred in the display 2 is identified can be reduced.

The structures illustrated in the above embodiment indicate exemplary contents of the present invention and can be combined with other known technique. Furthermore, the structures illustrated in the embodiment can be partially omitted and changed without departing from the scope of the present invention.

### REFERENCE SIGNS LIST

1 engineering tool; 2 display; 11, 21 display unit; 12, 22 input unit; 13, 23 calculation unit; 14, 24 storage unit; 15, 26 communication unit; 25 device memory; 31 internal device search unit; 32 list display processing unit.

1. An engineering tool of a programmable display, comprising:
internal device search circuitry configured to obtain data including a device or a label from the programmable display and search the obtained data for first data including an internal device that is a device storing a device value updated in the programmable display in association with an operation of the programmable display and second data including the label indicating the internal device; and
list display processing circuitry configured to read out a device value corresponding to the internal device included in the first data and a device value corresponding to the label included in the second data from the programmable display and to cause a display to display the read out device values and using part indicating screen data of a screen among a plurality of screens displayed by the programmable display in which the device value is used.

2. The engineering tool according to claim 1, wherein
the list display processing circuitry causes the display to display a list of the device value, the using part, and information on a page in a manual in which description of the device value is written.

3. The engineering tool according to claim 1, wherein
the list display processing circuitry causes the display to display a list of the device value, the using part, and a name of a device corresponding to the device value.

4. The engineering tool according to claim 2, wherein
the list display processing circuitry causes the display to display a list of the device value, the using part, and a name of a device corresponding to the device value.
